(19) United States
(12) Patent Application Publication
(10) Pub. No.: US 2010/0096388 A1
(43) Pub. Date: Apr. 22, 2010

(54) METHOD OF MELT-ADHERING A MEMBER HAVING A LAYER OF A THERMOPLASTIC RESIN AND THERMOPLASTIC RESIN CONTAINER WITH LID

(75) Inventors: Tomokazu Kobayashi, Yokohami-shi (JP); Hironori Kobayashi, Yokohami-shi (JP); Yoshinori Asada, Yokohama-shi (JP); Akiko Kondo, Yokohama-shi (JP); Shouichi Inaba, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyo Seikan Kaisha, Ltd, Chiyoda-ku, Tokyo (JP)

(21) Appl. No.: 12/528,250

(22) PCT Filed: Feb. 18, 2008
(86) PCT No.: PCT/JP2008/052653

§ 371 Date: Sep. 25, 2009

(30) Foreign Application Priority Data
Feb. 23, 2007 (JP) 2007-043738

(51) Int. Cl. B65D 50/00; B32B 37/06; B65B 7/00

(52) U.S. Cl. 220/359.4; 156/272.8; 156/69

(57) ABSTRACT

A method of melt-adhering together a member (A) having a layer (a) of a thermoplastic resin exposed on at least a portion on the surface on the outer side thereof and a member (B) having a layer (b) of a thermoplastic resin exposed on at least the surface on the inner side thereof, wherein a self-press holding mechanism is formed on the portions on where the layer (a) and the layer (b) are to be melt-adhered together to press the member (A) and the member (B) onto each other and to hold the pressed state thereof, and the press-adhered portion is irradiated with a laser beam in a state where the layer (a) and the layer (b) are press-adhered together to effect the melt-adhesion. Therefore, the melt-adhesion is effected even without fixing the portions to be melt-adhered together by using an external pressing mechanism, and the container can be sealed at high speeds and stably despite the member thereof has a relatively large thickness.

### TECHNICAL FIELD

The present invention relates to a method of melt-adhering together members having a layer of a thermoplastic resin exposed on at least portions thereof and, particularly, to a method of melt-adhering a container and a lid together. More specifically, the invention relates to a method of melt-adhering a container and a lid together, capable of sealing a container at high speeds and stably despite the member thereof has a relatively large thickness, and to a thermoplastic resin container with lid sealed by the above melt-adhering method.

### BACKGROUND ART

In a conventional thermoplastic resin container having a layer of a thermoplastic resin, for example, a flange portion is formed along the opening portion of a cup, and a lid comprising a film or a sheet is heat-sealed (heat-melt-adhered) to the flange portion to obtain a sealed container.

The heat-sealing is such a convenient method that it has been generally and widely employed requiring, however, the time for the step of heat-melt adhesion and for the subsequent step of cooling. Therefore, it has been desired to improve the production efficiency.

In a general heat-sealing system that uses a heat-sealing bar, further, the melt-adhering portion requires a certain degree of areas and, besides, the melt-adhering surface must be flat. Besides, the heat must be conducted to the sealing surface from the outer surface of the melt-adhering portion. In the case of a thick container, therefore, an extended period of time is required for the conduction, decreasing the productivity and, therefore, arousing such problems as limitation on the thickness and a low degree of freedom in the shape. Moreover, an extended period of time is required until the heat-sealed portion is cooled and is completely sealed. When the container is to be charged with a content that spontaneously produces pressure or is to be hot-charged, therefore, the gas in the head space expands due to the heat of sealing and may escape through the sealed portion in the molten state, and the sealing may peel off.

To solve the above problem, a method has also been proposed to melt-adhere the container member by using a laser beam. For example, the following patent document 1 discloses a method of producing a container for medical use obtained by mounting a port member on a sheet or a film of a thermoplastic resin, the port member being formed by using a thermoplastic resin which is the same as, or different from, the above sheet or film, the method comprising a first step of false-anchoring the port member to a predetermined position of the bag-like sheet or film, and a second step of irradiating the false-anchored portion of the bag-like sheet or film and the port member with a laser beam to melt-adhere the false-anchored portion.

Patent document 1: JP-A-2004-267384

### DISCLOSURE OF THE INVENTION

### Problems to be Solved by the Invention

According to the method of melt-adhering the container member by using the laser beam as described above, melt-adhesion takes place immediately after the irradiation with the laser beam as compared to the conventional melt-adhesion by heat-sealing. Therefore, the time required for the melt-adhesion can be shortened, and the melt-adhesion can be reliably attained without imposing limitation on the shape.

To effect the melt-adhesion by the irradiation with a laser beam, however, the members to be melt-adhered together must be closely contacted to each other. In order to improve the efficiency of melt-adhesion according to the above patent document 1, the portions to be melt-adhered are false-anchored by using a pressing mechanism such as a mechanical pressing mechanism or a pneumatic pressing mechanism. Namely, the pressing mechanism must be separately provided and, besides, the false-anchoring step must be provided making it difficult to greatly shorten the time (to increase the speed) or to cut down the cost.

It is, therefore, an object of the present invention to provide a melt-adhering method capable of effecting the melt-adhesion with a laser beam even if the portions to be melt-adhered together have not been fixed by using an external pressing mechanism, and of sealing the container at high speeds and stably despite the member thereof has a relatively large thickness.

Another object of the present invention is to provide a thermoplastic resin container with lid having a self-press holding function in the engaging portion in the state of being fitted.

### Means for Solving the Problems

According to the present invention, there is provided a method of melt-adhering together a member (A) having a layer (a) of a thermoplastic resin exposed on at least a portion on the surface on the outer side thereof and a member (B) having a layer (b) of a thermoplastic resin exposed on at least the surface on the inner side thereof, wherein a self-press holding mechanism is formed on the portions on where the layer (a) and the layer (b) are to be melt-adhered together to press the member (A) and the member (B) onto each other and to hold the pressed state thereof, and the press-adhered portion is irradiated with a laser beam in a state where the layer (a) and the layer (b) are press-adhered together to effect the melt-adhesion.

In the melt-adhering method of the present invention, it is desired that:

1. The self-press holding mechanism works to press and hold the member (A) and the member (B) by utilizing the elasticity of the member (A) and/or the member (B);
2. The self-press holding mechanism is based upon an interference formed between the member (A) and the member (B) in a state where the member (A) and the member (B) are fitted to each other; and
3. The thermoplastic resin in the press-adhered portion is transparent or semitransparent and is capable of transmitting the laser beam, and a heat-generating member is formed in the interface or near the interface of the press-adhered portion to generate heat upon absorbing the laser beam.

According to the melt-adhering method of the invention, further, the member (A) is a container with its one end opened and its other end closed, the member (B) is a lid for sealing the opening portion of the container, and the opening portion of the container is sealed with the lid, wherein the self-press holding mechanism is formed on the portions on where the container and the lid are to be melt-adhered together to press the container and the lid onto each other and to hold the pressed state thereof, and the press-adhered portion is irradiated with a laser beam in a state where the layers of the thermoplastic resins of the container and the lid are press-adhered together to effect the melt-adhesion.

In this embodiment, it is desired that:

1. The thermoplastic resin in the press-adhered portion of the flange portion of the container and/or the lid is transparent or semitransparent and is capable of transmitting the laser beam, and a heat-generating member is formed near the interface of the press-adhered portion to generate heat upon absorbing the laser beam; and
2. The container is a cup-type container having a flange portion, and has a protuberance for pushing down the upper surface of the flange portion of the container in a state where the container and a lid are in a state of being fitted together, or forms an interference between the outer diameter of the flange portion of the container and the inner diameter of the lid.

According to the present invention, further, there is provided a thermoplastic resin container with lid comprising a thermoplastic resin container having a layer of a thermoplastic resin on at least a flange portion thereof and a lid for sealing upon being melt-adhered onto the flange portion of the container, wherein a self-press holding mechanism is formed on the portions on where the container and the lid are to be melt-adhered together to press the container and the lid onto each other and to hold the pressed state thereof in a state where the container and the lid are fitted together, and the thermoplastic resin container and the lid are melt-adhered together with a laser beam at the press-adhered portion thereof so as to be integrally formed together.

### EFFECT OF THE INVENTION

According to the melt-adhering method of the invention, the self-press holding mechanism is formed between the container and the lid. Therefore, the container and the lid which are simply being fitted together can be melt-adhered together with the laser beam, and the container can be efficiently sealed with the lid.

According to the melt-adhering method of the present invention, further, the sealing can be accomplished at a high speed, stably and at a decreased cost despite the member has a relatively large thickness.

Further, the self-press holding mechanism eliminates the need of fixing the container and the lid together by using an external pressing member at the time of melt-adhering them together by the irradiation with the laser beam. Therefore, the melt-adhesion can be attained by the irradiation with the laser beam not only from the up-and-down direction but also from the side surface providing freedom for designing the shape of the container or the lid.

No cooling step is required unlike the conventional method that effects the melt-adhesion by heat-sealing using a hot plate. Namely, the cooling step is eliminated and the productivity can be improved.

### BRIEF DESCRIPTION OF THE DRAWINGS

FIG. 1 is a side sectional view of a thermoplastic resin container with lid of the present invention;

FIG. 2 is a sectional view illustrating, on an enlarged scale, the melt-adhered portion of the thermoplastic resin container with lid of FIG. 1;

FIG. 3 is a view illustrating a step of melt-adhering the thermoplastic resin container with lid of FIG. 1;

FIG. 4 is a side sectional view illustrating another example of the thermoplastic resin container with lid of the present invention;

FIG. 5 is a side sectional view illustrating a further example of the thermoplastic resin container with lid of the present invention;

FIG. 6 is a side sectional view illustrating a still further example of the thermoplastic resin container with lid of the present invention;

FIG. 7 is a view illustrating a cup-type container with lid used in Example 1; and

FIG. 8 is a view illustrating tubes used in Example 2.

### BEST MODE FOR CARRYING OUT THE INVENTION

According the melt-adhering method of the present invention, an important feature resides in that a member (A) having a layer (a) of a thermoplastic resin exposed on at least a portion on the surface on the outer side thereof and a member (B) having a layer (b) of a thermoplastic resin exposed on at least the surface on the inner side thereof are melt-adhered together, wherein a self-press holding mechanism is formed on the portions on where the layer (a) and the layer (b) are to be melt-adhered together to press the member (A) and the member (B) onto each other and to hold the pressed state thereof, and the press-adhered portion is irradiated with a laser beam in a state where the layer (a) and the layer (b) are press-adhered together to effect the melt-adhesion.

The melt-adhering method of the present invention will now be described with reference to the accompanying drawings in a case where the member (A) is a container with its one end opened and its other end closed, the member (B) is a lid for sealing the opening portion of the container, and the container and the lid are to be melt-adhered together.

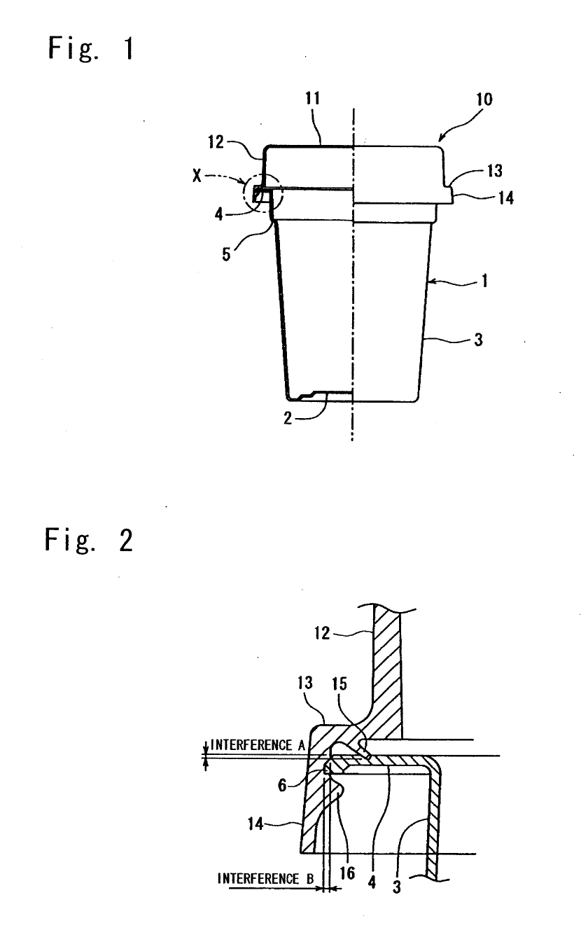

FIG. 1 is a sectional view illustrating a container and a lid used in the melt-adhering method of the present invention, and FIG. 2 is a partial sectional view illustrating a fitting portion (X) of FIG. 1 on an enlarged scale.

The thermoplastic resin container generally designated at 1 roughly comprises a bottom portion 2, a body portion 3 and a flange portion 4. A stack portion 5 is formed at an upper part of the body portion 3, and an engaging protuberance 6 is formed along the outer circumferential edge of the flange portion 4 to engage with a lid that will be described later.

The lid 10 has the shape of an over-cap comprising roughly a top plate portion 11 and a skirt portion 12 hanging down from the outer circumferential end portion of the top plate portion 11. The lid 10, further, includes a horizontal step portion 13 extending outward in the horizontal direction from the lower end of the skirt portion 12, and a fitting portion 14 hanging down from the outer circumferential end portion of the horizontal step portion 13. A thin annular protruding piece 15 is formed on the inner surface side of the horizontal step portion 13 facing inward in the radial direction. Further, an annular protuberance 16 is formed on the inner surface of the fitting portion 14 to engage with the engaging protuberance 6 of the container.

According to the present invention, a distance H2 between the inner surface of the horizontal step portion 13 and the upper surface of the flange portion 4 in a state where the engaging protuberance 6 of the thermoplastic resin container having the above structure is engaged with the annular protuberance 16 of the lid 10, is shorter than a length H1 of the annular protruded piece 15 of the lid 10 in a state where the lid has not been fitted to the thermoplastic resin container, and the outer diameter D1 of the flange portion is larger than the inner diameter D2 of the lid 10 at a position where the engaging protuberance 6 of the fitting portion 14 comes in contact. As shown in FIG. 2, therefore, an interference A (H1-H2) and an interference B (D1-D2) are formed between the lid 10 and the thermoplastic resin container 1 in the fitted state in the up-and-down direction and in the radial direction.

In a state where the lid 10 is fitted to the thermoplastic resin container 1, therefore, the annular protruding piece 15 having a small thickness of the lid exhibits elasticity. Therefore, the annular protruding piece 15 is pressed and deformed by the flange portion 4 of the thermoplastic resin container 1, and the pressed state is maintained by the engagement of the engaging protuberance 6 of the flange portion 4 of the thermoplastic resin container 1 with the annular protuberance 16 of the lid 10.

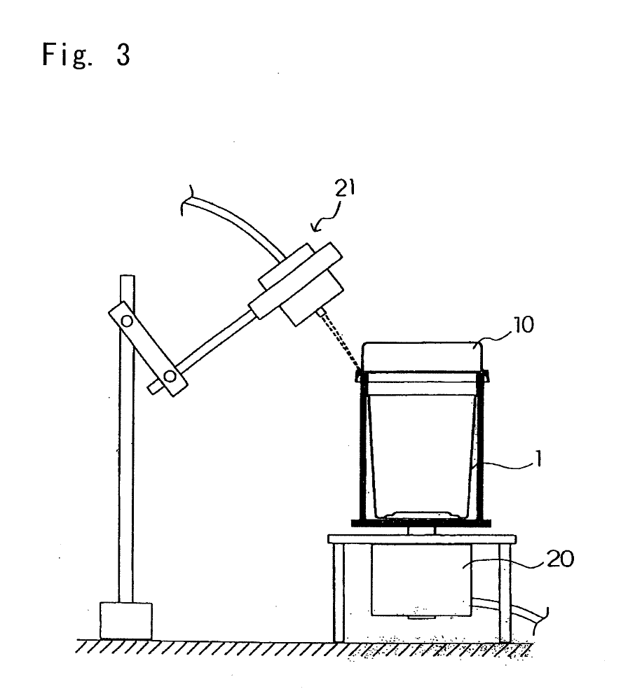

FIG. 3 is a view illustrating the thermoplastic resin container with lid irradiated with a laser beam in a state where the portions of the container and of the lid to be melt-adhered together are maintained pressed.

In order to melt-adhere together the thermoplastic resin container 1 and the lid 10 according to the present invention in a state of being pressed as shown in FIG. 3, the thermoplastic resin container with lid in a state of being fitted together is set onto a rotor 20, and a laser beam from a laser oscillator (not shown) through a glass fiber is projected via a focusing lens 21 onto the press-adhered portion of the annular protruding piece 15 of the lid and the upper surface of the flange portion 4 of the thermoplastic resin container 1 to thereby melt-adhere the annular portions that are to be melt-adhered together and, therefore, to seal the thermoplastic resin container 1 with the lid 10.

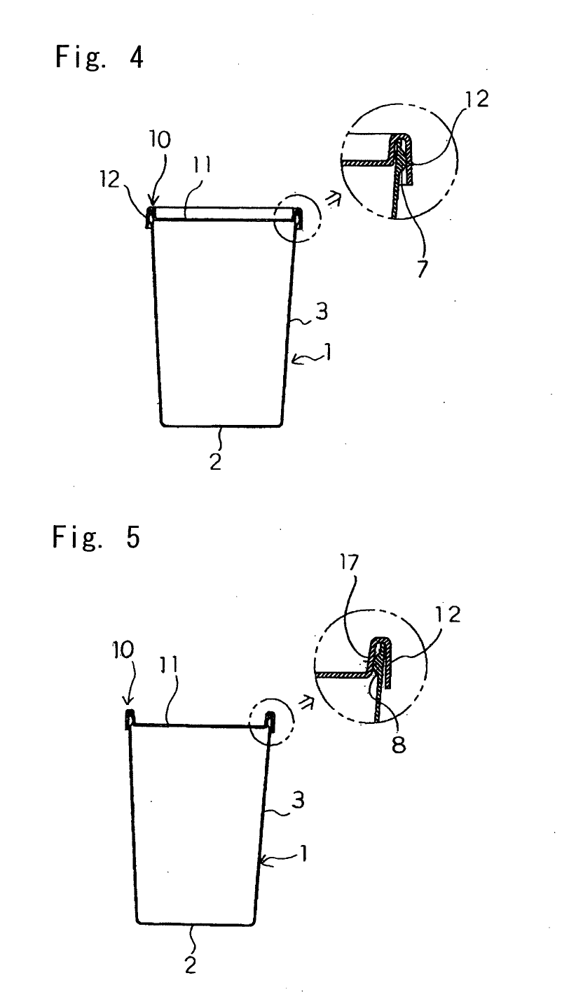

FIGS. 4 to 6 are sectional views illustrating other examples of the container and the lid on which the self-press holding mechanism is formed that can be applied to the melt-adhering method of the present invention.

The thermoplastic resin container 1 shown in FIG. 4 comprises the bottom portion 2 and the body portion 3, and has an annular protuberance 7 protruding outward at an upper end of the body portion 3. The lid 10, on the other hand, comprises the top plate portion 11 and the skirt portion 12, the top plate portion 11 sinking toward the container side to form a sunk lid shape.

In this embodiment, the outer diameter of the thermoplastic resin container 1 at the position of the annular protuberance 7 is larger than the inner diameter of the skirt portion 12 of the lid 10 at the position where it comes in contact with the annular protuberance 7. In a state where the thermoplastic resin container 1 and the lid 10 are fitted together, the skirt portion 12 of the lid 10 is pressed by the annular protuberance 7 of the thermoplastic resin container 1.

In this embodiment, the lid 10 is made of, for example, a thermoplastic resin which is capable of transmitting the laser beam, the container 1 has an outer layer on at least a portion of the annular protuberance 7, the outer layer comprising the same resin as that of the lid 10, and heat-generating portion is formed on the inside of the outer layer. Upon irradiating the position of the annular protuberance 7 with a laser beam from any position on the outer side and from any of transverse direction, upper tilted direction or lower tilted direction, the thermoplastic resin container and the lid can be melt-adhered together.

A combination of the container and the lid shown in FIG. 5 is nearly the same as the embodiment shown in FIG. 4 except that an annular protuberance 8 is formed protruding inward at an upper end of the body portion 3 of the thermoplastic resin container 1.

In this embodiment, the inner diameter of the thermoplastic resin container 1 at the position of the annular protuberance 8 is larger than the outer diameter of the side wall of sunk portion of top plate portion 11 of the lid 10. In a state where the thermoplastic resin container 1 and the lid 10 are fitted together, the side wall 17 of sunk portion of the lid 10 is pressed by the annular protuberance 8 of the thermoplastic resin container 1.

In this embodiment, the lid 10 is formed by using, for example, a thermoplastic resin capable of transmitting the laser beam, the container 1 has an inner layer on at least a portion of the annular protuberance 8, the inner layer comprises the same resin as that the lid 10, and the heat-generating portion is formed on the outside of the inner layer. Upon irradiating the position of the annular protuberance 8 with a laser beam from a position on the center side of top plate portion of the lid from any of transverse direction, upper tilted direction or lower tilted direction, therefore, the thermoplastic resin container and the lid can be melt-adhered together.

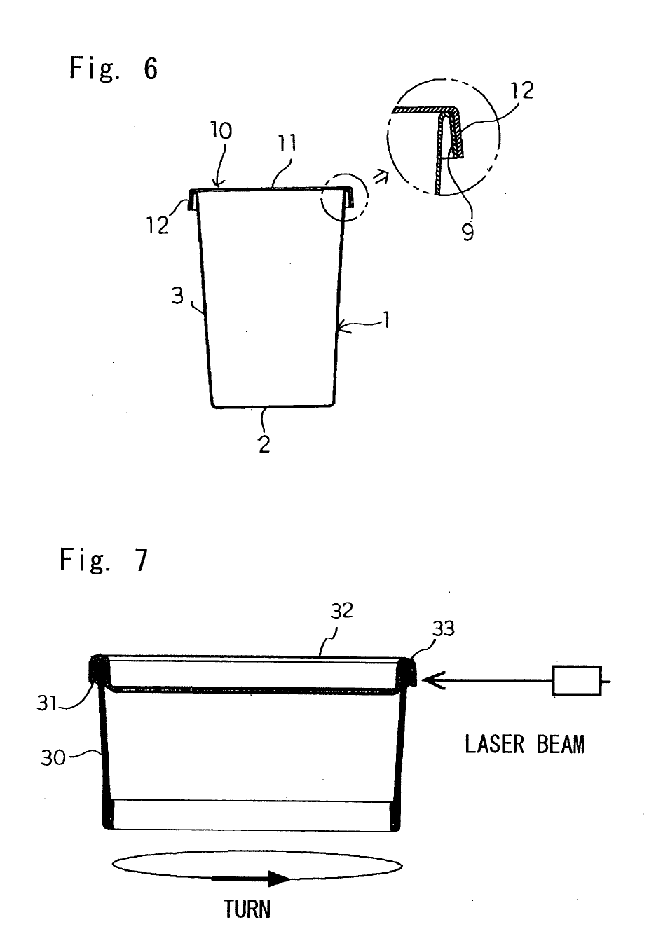

The thermoplastic resin container 1 shown in FIG. 6 comprises the bottom portion 2 and the body portion 3, and has a flange portion 9 with its end facing downward at an upper end of the body portion 3. The lid 10, on the other hand, comprises the top plate portion 11 and the skirt portion 12, the inner diameter of the skirt portion 12 of the lid 10 being smaller than the outer diameter of the flange portion 9. Therefore, upon fitting the lid 10 to the thermoplastic resin container 1, the flange portion 9 of the thermoplastic resin container 1 is pressed from the outer side by the skirt portion 12 of the lid 10.

In this embodiment, the lid 10 is formed by using, for example, a thermoplastic resin which is capable of transmitting the laser beam, the container 1 has an inner layer on at least the flange portion 9, the inner layer comprising the same resin as that of the lid 10, and heat-generating portion is formed on the outside of the inner layer. Upon irradiating the position where the flange portion 9 of the thermoplastic resin container 1 and the skirt portion 12 of the lid 10 are press-adhered together with a laser beam from any of outer transverse direction, upper tilted direction or lower tilted direction, the thermoplastic resin container and the lid can be melt-adhered together and sealed.

Combinations of the container and the lid having the self-press holding mechanism that can be used in the melt-adhering method of the invention are not limited to the above-mentioned examples only but can be modified in a variety of other ways.

In the embodiment shown in FIG. 4, for example, the lid may not assume the sunk lid shape but may comprise the top plate portion and the skirt portion as shown in FIG. 6, as a matter of course.

Further, the sectional shape of the container is not limited to the circular shape only but may assume a variety of sectional shapes, such as rectangular shape, polygonal shape or a shape having dents and protuberances.

The flange does not necessarily have to be formed in the horizontal direction like that of the conventional thermoplastic resin containers. In the case of, for example, a container for beverage, therefore, the user will find it easy to drink with his mouth being in direct tough with the container.

Combinations of the container and the lid that can be used in the melt-adhering method of the invention must be such that at least the melt-adhering portion on the side on where the laser beam falls is transparent or semitransparent to permit the passage of the laser beam, so that the melt-adhesion can be accomplished with the laser beam, and that a heat-generating member is provided near the interface of the melt-adhering portion to convert the laser beam into heat. It is further desired that the portions of the container and the lid to be melt-adhered together are of the same kind of resin.

As the resin for forming a transparent or semitransparent layer capable of transmitting the laser beam, there can be used a thermoplastic resin that has heretofore been used for packages and containers. In particular, olefinic resins and polyester resins can be preferably used.

The heat-generating portion may be formed on either the container or the lid, but is preferably formed near the interface of the container and the lid from the standpoint of melt-adhering efficiency. As the material for constituting the heat-generating portion, there can be used a metal such as a metal foil or a metal plate, a coating comprising a colored coating material of, for example, black color, a resin containing an oxygen absorber such as iron powder or carbon black, or the melt-adhered portion itself may be formed by using a polyamide resin, a polyester resin, a polyurethane resin or the like resin capable of generating heat by itself upon the irradiation with a laser beam.

As the material for constituting either the container or the lid, there can be preferably used a laminate having at least two layers including a layer of a thermoplastic resin capable of transmitting the laser beam and a layer that serves as the heat-generating portion since there is no need of separately forming the heat-generating portion. Though not limited thereto only, there can be exemplified a laminate of three-layer constitution including an outer layer and an inner layer of a thermoplastic resin capable of transmitting the laser beam, and an intermediate layer such as of a polyamide resin, a resin containing an iron-type oxygen absorber or an aluminum foil that serves as the heat-generating portion.

It is, of course, allowable to separately form a heat-generating portion on the melt-adhering portion only, such as forming a black coating on the melt-adhering portion.

It is, further, allowable to form the container by using a resin-coated metal plate and to use it in combination with the lid made of a resin which is capable of transmitting the laser beam.

It is, further, allowable to form both the container and the lid by using a resin-coated metal plate. In this case, the container and the lid are formed in shapes as shown in, for example, FIG. 4, and the press-held portion of the container and the lid is directly irradiated with the laser beam from the lower side to melt-adhere them together.

It is desired that the thermoplastic resin layer that is formed on the container and on the lid, and is to be melt-adhered, has a thickness in a range of 0.05 to 20 mm and, particularly, 0.3 to 10 mm. If the thickness is smaller than the above range, the sealing by the melt-adhesion is not attained to a sufficient degree. If the thickness is larger than the above range, the efficiency of melt-adhesion may decrease.

The melt-adhering method of the present invention makes it possible to melt-adhere together the members having layers of various thermoplastic resins maintaining stability at a low cost so far as they are capable of forming the above-mentioned self-press holding mechanism. In particular, the melt-adhering method of the invention can be preferably applied to the containers formed by a known production method such as compressed-air forming, blow forming, injection forming or compression forming. That is, the melt-adhering method of the present invention is capable of melt-adhering even those containers having a relatively large thickness at a high speed and stably, and can be applied to even those containers obtained by the injection forming. Further, the shape is not limited to that of the thermoplastic resin container that is shown but can be modified to be that of a tray, a bottle or various other shapes.

The lid, too, may be the one produced by a known production method such as compressed-air forming, injection forming or compression forming.

As described above, the melt-adhering method of the present invention can be applied to the containers and the lids made from a resin-coated metal plate, too. As the metallic containers, there can be exemplified welded cans and two-piece cans.

The laser beam used in the present invention may be the one of a gas laser, a solid laser or a semiconductor laser.

Among them, the semiconductor laser can be preferably used.

It is desired that the output of the laser oscillator is in a range of 20 to 150 W and, particularly, 30 to 100 W. It is, further, desired that the wavelength of the laser beam is 200 nm to 20 μm and, particularly, 400 nm to 15 μm. In a commercial sense, they are determined based on the transparency of the resin, properties of the material that generates heat upon absorbing the laser beam, output of the laser oscillator, cost and safety.

In the present invention, it is desired that the laser beam has a spot diameter in a range of 0.2 to 3 mm and, particularly, 0.5 to 2 mm from the standpoint of sealing the container.

It is, further, desired that the focal distance of the laser beam is in a range of 10 to 200 mm and, particularly, in a range of 50 to 15 mm. Namely, it is desired that the focal distance is in a range of 30 to 70 mm to which is further added the thickness of the layer which is capable of transmitting the laser beam from the standpoint of preventing the deterioration of the resin yet maintaining sealing by the melt-adhesion.

It is, further, desired that the sweeping speed of the laser beam is in a range of 50 to 300 mm/sec. and, particularly, 100 to 200 mm/sec. from the standpoint of preventing the deterioration of the resin yet maintaining sealing by the melt-adhesion.

The melt-adhering method of the present invention makes it possible to efficiently attain the melt-adhesion by irradiating the press-adhered portion having the above self-press holding mechanism with the laser beam and, particularly, to melt-adhere a container maintaining uniform and strong air rightness by simply irradiating the container with the laser beam while turning the container.

The melt-adhesion can be attained under various conditions provided the heat is obtained in an amount sufficient for heating the melt-adhering portion at a temperature higher than the melting point thereof. If, for example, it is attempted to shorten the melt-adhering time, the laser output may be increased and the rotational speed may be increased, too. If it is not allowed to use the laser of a large output, then, the melt-adhering portion may be irradiated for an extended period of time. In the case of a container, the rotational speed of the container may be decreased down. Further, if the laser output that is obtained is large enough for melting, then the spot diameter of the laser beam may be increased to increase the width of melt-adhesion.

### EXAMPLES

### Example 1

A cup-type polypropylene container 30 of a thickness of 1 mm with lid was prepared having a shape as shown in FIG. 7, with its one end opened, with its other end closed, and having an inner diameter at the open end of 65 mm.

The cup 30 possessed a protruded portion 31 formed at the open end thereof over the whole circumference and protruding outward. On the protruded portion 31 was applied a coating material (Macky Black or Red manufactured by Zebra Co. or e-BIND manufactured by Orient Kagaku Kogyo Co.) that generates heat upon absorbing the laser beam) to form a laser absorber.

A polypropylene lid 32 of a thickness of 1 mm was used having a hooked engaging portion 33 formed by folding the flange thereof.

The inner diameter of the hooked engaging portion 33 was constituted to be smaller by about 0.3 mm than a maximum outer diameter of the protruded portion 31 of the container 30, and a difference therebetween was used as an interference.

The hooked engaging portion 33 of the lid 32 was fitted so as to cover the protruded portion 31 of the container 30 so that the fitted portion was press-adhered.

Under the fitted and press-adhered state, the whole container was rotated about the center axis of the cylindrical plane thereof so that the press-adhered portion to be irradiated with the laser beam moved at speeds as shown in Table 1. Semiconductor laser beams of a wavelength of 808 nm having outputs and laser beam diameters as shown in Tables 1 to 3 were projected onto the press-adhered portion so as to be vertical to the center axis of the container from a fixed position which was about 100 mm apart. The results of melt-adhesion by the irradiation with laser beams were as shown in Tables 1 to 3.

TABLE 1

| Sweeping | Laser | Spot diameter | Quality of | |
|---|---|---|---|---|
| speed | output | of laser beam | melt- | |
| (mm/sec) | (W) | (mm) | adhesion | State |
| 400 | 30 | 1.0 | X | poor |
| | | | | adhesion |
| 300 | 30 | 1.0 | Δ | weak |
| | | | | adhesion |
| 200 | 30 | 1.0 | ◯ | good |
| 100 | 30 | 1.0 | ◯ | good |
| 50 | 30 | 1.0 | Δ | scorched |
| 25 | 30 | 1.0 | X | melted and |
| | | | | deformed |

TABLE 2

| Sweeping | Laser | Spot diameter | Quality of | |
|---|---|---|---|---|
| speed | output | of laser beam | melt- | |
| (mm/sec) | (W) | (mm) | adhesion | State |
| 200 | 5 | 1.0 | X | poor |
| | | | | adhesion |
| 200 | 20 | 1.0 | Δ | weak |
| | | | | adhesion |
| 200 | 30 | 1.0 | ◯ | good |
| 200 | 100 | 1.0 | ◯ | good |
| 200 | 150 | 1.0 | Δ | scorched |
| 200 | 200 | 1.0 | X | melted and |
| | | | | deformed |

TABLE 3

| Sweeping | Laser | Spot diameter | Quality of | |
|---|---|---|---|---|
| speed | output | of laser beam | melt- | |
| (mm/sec) | (W) | (mm) | adhesion | State |
| 200 | 30 | 2.0 | Δ | scorched |
| 200 | 30 | 0.5 | ◯ | good |
| 200 | 30 | 1.0 | ◯ | good |
| 200 | 30 | 2.0 | Δ | weak |
| | | | | adhesion |
| 200 | 30 | 5.0 | X | poor |
| | | | | adhesion |
| 200 | 60 | 1.5 | ◯ | good |
| 200 | 60 | 2.0 | ◯ | good |
| 200 | 60 | 3.0 | Δ | weak |
| | | | | adhesion |

### Example 2

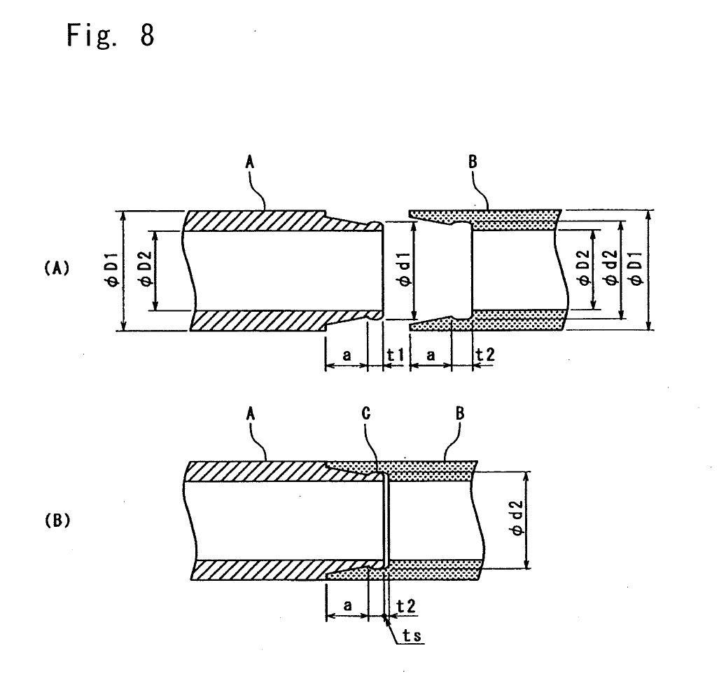

Referring to FIG. 8(A), a tube A made from a laser beam-absorbing resin and a tube B made from a laser beam-transmitting resin were melt-adhered together.

The tube A having of an inner diameter φD2 and an outer diameter φD1, and having a protuberance of an outer diameter φd1 at both ends thereof, and the tube B having an inner diameter φd2 smaller than φd1, were pushed from the right and left directions and were fitted together as shown in FIG. 8(B).

When fitted, the end of φd1 was pressed to become smaller in diameter than the inner diameter φd2 without almost causing a change in the volume. Therefore, the thickness t1 of the protuberance was broadened as designated at t2 in FIG. 8(B), and the pressing force was produced between the two diameters.

While turning the tube A and the tube B which are being fitted together, a laser beam was projected onto the pressed portion C from the outer surface side. The beam that has transmitted through the tube B of the laser beam-transmitting resin was absorbed by the tube A of the laser beam-absorbing resin generating heat, whereby the fitted portion of the tube A was melted, the temperature of melting was transmitted to the resin forming the tube B on the outer side, the two resins were melted in the interface of the tube A and the tube B, and were naturally melt-adhered together under the application of pressing force.

1. A method of melt-adhering together a member (A) having a layer (a) of a thermoplastic resin exposed on at least a portion on the surface on the outer side thereof and a member (B) having a layer (b) of a thermoplastic resin exposed on at least the surface on the inner side thereof,
wherein a self-press holding mechanism is formed on the portions on where said layer (a) and said layer (b) are to be melt-adhered together to press the member (A) and the member (B) onto each other and to hold the pressed state thereof, and the press-adhered portion is irradiated with a laser beam in a state where said layer (a) and said layer (b) are press-adhered together to effect the melt-adhesion.

2. The melt-adhering method according to claim 1, wherein said self-press holding mechanism works to press and hold the member (A) and the member (B) by utilizing the elasticity of the member (A) and/or the member (B).

3. The melt-adhering method according to claim 1, wherein said self-press holding mechanism is based upon an interference formed between the member (A) and the member (B) in a state where the member (A) and the member (B) are fitted to each other.

4. The melt-adhering method according to claim 1, wherein the thermoplastic resin in the press-adhered portion is transparent or semitransparent and is capable of transmitting the laser beam, and a heat-generating member is formed in the interface or near the interface of the press-adhered portion to generate heat upon absorbing the laser beam.

5. The melt-adhering method according to claim 1, wherein said member (A) is a container with its one end opened and its other end closed, said member (B) is a lid for sealing the opening portion of the container, and the opening portion of the container is sealed with the lid, and
wherein the self-press holding mechanism is formed on the portions on where said container and said lid are to be melt-adhered together to press said container and said lid onto each other and to hold the pressed state thereof, and the press-adhered portion is irradiated with a laser beam in a state where the layers of the thermoplastic resins of said container and said lid are press-adhered together to effect the melt-adhesion.

6. The melt-adhering method according to claim 5, wherein said container is a cup-type container having a flange portion, and has a protuberance for pushing down the upper surface of the flange portion of said container in a state where said container and a lid are in a state of being fitted together, or forms an interference between the outer diameter of the flange portion of said container and the inner diameter of said lid.

7. A cup-type thermoplastic resin container with lid comprising a container having a layer of a thermoplastic resin and a lid for sealing an end portion of said container by melt-adhesion, wherein a self-press holding mechanism is formed on the portions on where said container and said lid are to be melt-adhered together to press said container and said lid onto each other and to hold the pressed state thereof in a state where said container and said lid are fitted together, and said container and said lid are melt-adhered together with a laser beam at the press-adhered portion thereof so as to be integrally formed together.
